(19) United States
(12) Patent Application Publication
(10) Pub. No.: US 2015/0301559 A1
(43) Pub. Date: Oct. 22, 2015

(54) APPARATUS FOR MOUNTING A MOBILE DEVICE TO A DISPLAY

(71) Applicants: Edward Wu, Long Island City, NY (US); Amy Wu, Long Island City, NY (US)

(72) Inventors: Edward Wu, Long Island City, NY (US); Amy Wu, Long Island City, NY (US)

(21) Appl. No.: 14/691,736

(22) Filed: Apr. 21, 2015

Related U.S. Application Data
(60) Provisional application No. 61/981,856, filed on Apr. 21, 2014.

(51) Int. Cl. G06F 1/16; F16M 13/02; A47B 97/00

(52) U.S. Cl. CPC G06F 1/1607; A47B 97/00; F16M 13/022; A47B 2097/005

(57) ABSTRACT

A mounting apparatus for supporting a mobile device on a display includes a base, a stem portion, and an article receiver. The base is configured to engage the display. The stem portion extends from the base. The article receiver coupled to the stem portion. The article receiver is configured to releasably receive the mobile device.

### CROSS-REFERENCE TO RELATED APPLICATION

This application claims priority to and the benefit of U.S. Provisional Patent Application No. 61/981,856, filed on Apr. 21, 2014, the entire contents which are hereby incorporated by reference.

### BACKGROUND

1. Technical Field

The present disclosure relates to an apparatus for mounting a mobile device to a display, and more particularly, to an adjustable mount for supporting a mobile device on a display and a method of use therefore.

2. Background of Related Art

Through various wired or wireless means for data transfer and/or communication, the audio and visual content that would otherwise appear only on the screen of a mobile device, such as a smartphone, can be mirrored or otherwise transferred to a display, such as a television. Additionally, certain mobile devices have the capability for video-conferencing to be accomplished directly on the mobile device itself. Therefore, it may be possible to accomplish video conferencing on a television by mirroring or otherwise transferring to the television the audio and visual contents of a smartphone that is being used for video-conferencing. Due to its size, a television screen may be more comfortably viewed during a video-conference than a smartphone screen.

However, to adequately video-conference in such a manner, there is a need for a device that mounts the mobile device on to the display while providing an optimal placement of the mobile device on the display. The reason is, during a video-conference, a user will naturally look at the display in order to view the video-conferencing image feed from the other party. If the built-in camera on the mobile device is not positioned for eye-contact with the user while the user looks at the display, the party that the user is video-conferencing with will receive an image feed of the user looking away. Additionally, if the mobile device is not elevated to a proper height, the other party may see the user from a vantage point that is unnatural for the purpose of video-conferencing.

### SUMMARY

In accordance with an embodiment of the present disclosure, there is provided a mounting apparatus for supporting a mobile device on a display. The mounting apparatus includes a base, a stem portion, and an article receiver. The base is transitionable between an undeformed state and a deformed state. The base includes a first end and a second end. The first end includes a weighted mass having a predetermined weight. The stem portion extends from the second end of the base. The article receiver is adjustably coupled to the stem portion. The article receiver has first and second arms configured for relative movement between a retracted position and an expanded position. The first and second arms are configured to securely engage the mobile device therebetween.

In an embodiment, the base may include a bendable member. The base may further include a casing member dimensioned to enclose the bendable member therein. In particular, the casing member may define a cavity configured to receive the weighted mass therein. In an embodiment, the weighted mass may be detachably supported within the cavity of the casing member. Alternatively, the weighted mass and the casing member may be integrally formed.

In another embodiment, the mounting apparatus may further include an anchoring portion extending laterally from the second end of the base. The anchoring portion may include an anterior surface and a posterior surface including a liner formed of a compressible material. The anchoring portion may define a lateral axis, and the stem portion may define an acute angle with respect to the lateral axis.

In another embodiment, the stem portion and the article receiver may include a ball and socket joint. The stem portion may include an anterior surface and a posterior surface. The article receiver may be coupled to the anterior surface of the stem portion. The posterior surface of the stem portion may include a pair of teeth configured to receive a cable therebetween. The pair of teeth may be formed of a compressible material.

In yet another embodiment, the first and second arms of the article receiver may be biased toward the retracted position.

In accordance with another aspect of the present disclosure, there is provided a method of mounting a mobile device to a display. The method includes providing a mounting device including a base, a stem portion, and an article receiver. The method further includes placing the mobile device on the article receiver and placing the mounting device on the display.

In an embodiment, placing the mounting device on the display may include positioning the mobile device above the display. In addition, placing the mounting device on the display may include positioning the mobile device anterior to the display.

In another embodiment, the method of mounting a mobile device to a display may include connecting the mobile device to the display through either a wired or wireless connection to facilitate data transfer and other communication between the mobile device and the display. In addition, the method may also comprise connecting the mobile device to a computer through either a wired or wireless connection to facilitate data transfer and other communication between the mobile device and the computer. Furthermore, the method may comprise adjusting an orientation of the mobile device such that a camera of the mobile device is positioned at an eyelevel of a user.

### BRIEF DESCRIPTION OF THE DRAWINGS

Various embodiments of the present disclosure are described hereinbelow with reference to the drawings, wherein:

FIG. 1 is a front view of an embodiment of a mounting apparatus supporting a mobile device at a top portion of a display;

FIG. 2 is a perspective view of the mounting apparatus shown in FIG. 1;

FIG. 3 is a side view of the mounting apparatus shown in FIG. 1 illustrating use on the display;

FIG. 4 is a perspective view of an embodiment of an article receiver;

FIG. 5A is a perspective view of another embodiment of a mounting apparatus illustrating use on a display;

FIG. 5B is a side view of the mounting apparatus shown in FIG. 5A supporting a mobile device;

FIG. 6 is a perspective view of another embodiment of an article receiver that is supporting a mobile device;

FIG. 7 is a perspective view of another embodiment of an article receiver;

FIG. 8 is a perspective view of another embodiment of a mounting apparatus illustrating use on a display;

FIG. 9 is a perspective view of another embodiment of a mounting apparatus illustrating use on a display;

FIG. 10 is a front view of another embodiment of a mounting apparatus illustrating use on a display;

FIG. 11A is a perspective view of an embodiment of a base;

FIG. 11B is a bottom perspective view of the base shown in FIG. 11A;

FIG. 12 is a bottom perspective view of another embodiment of a base;

FIG. 13 is a rear perspective view of another embodiment of a base illustrating use on a display;

FIG. 14 is a rear perspective view of another embodiment of a base illustrating use on a display;

FIG. 15 is a rear perspective view of another embodiment of a base illustrating use on a display;

FIG. 16 is a side view of another embodiment of a mounting apparatus supporting a mobile device at a bottom portion of a display;

FIG. 17 is a rear perspective view of another embodiment of a mounting apparatus illustrating use on a display;

FIG. 18 is a top perspective view of a mounting apparatus in accordance with yet another embodiment of the present disclosure;

FIG. 19 is a bottom perspective view of the mounting apparatus of FIG. 18;

FIG. 20 is a side view of the mounting apparatus of FIG. 18;

FIG. 21 is a top perspective view of a body of the mounting apparatus of FIG. 18;

FIG. 22 is a partially exploded perspective view of the mounting apparatus of FIG. 18 with parts separated;

FIG. 23 is a side partially transparent view of the mounting apparatus of FIG. 18;

FIG. 24 is a front view of the mounting apparatus of FIG. 18;

FIG. 25 is a bottom perspective view of the mounting apparatus of FIG. 18 illustrating an article receiver in an expanded state;

FIG. 26 is an exploded perspective view of an article receiver of FIG. 25;

FIG. 27 is a perspective view of the mounting apparatus of FIG. 18 illustrating use on a display;

FIGS. 28 and 29 are perspective views of the mounting apparatus of FIG. 18 illustrating use on a display; and

FIGS. 30 and 31 are perspective views of the mounting apparatus of FIG. 18 illustrating standalone use without the display.

### DETAILED DESCRIPTION OF EMBODIMENTS

Embodiments of the present disclosure will now be described in detail with reference to the drawings, in which like reference numerals designate identical or corresponding elements in each of the several views. As used herein, the term “distal,” as is conventional, will refer to that portion of the instrument, apparatus, device or component thereof which is farther from the user while, the term “proximal,” will refer to that portion of the instrument, apparatus, device or component thereof which is closer to the user. In the following description, well-known functions or constructions are not described in detail to avoid obscuring the present disclosure in unnecessary detail. Relational and directional terms (e.g., upper, lower, above, left, and right, etc.) used herein are included to facilitate description and do not limit the scope, applicability, and/or configuration of the disclosure in any way. As used herein, the terms “includes,” “including,” “such as,” “e.g.,” and “for example” are not limiting. The term “or” does not express a choice between two mutually exclusive possibilities but, rather, may include all possibilities.

The present application relates to a mounting apparatus that may be used to mount a mobile device to a display. In some embodiments, a mobile device mounted to a display through a mounting apparatus may be received or supported by the mounting apparatus in a releasable manner. A mobile device received or supported by a mounting apparatus can take many forms, including, but not limited to, a smartphone, tablet computer, camera, or other electronic device. A display can also take many forms, including, but not limited to, a television, computer monitor, laptop computer monitor, tablet computer, or projection screen.

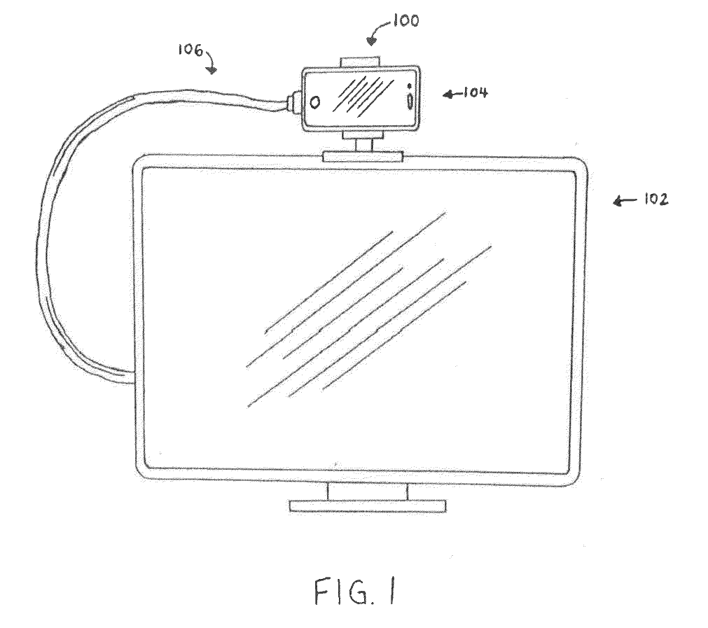

With reference to FIGS. 1-3, a mounting apparatus 100 is shown in accordance with one embodiment. In FIG. 1, mobile device 104 is releasably received or supported by mounting apparatus 100 near the top of display 102. Mobile device 104 is a smartphone. Display 102 in FIG. 1 is a television. Cable 106 is connected on one end to mobile device 104 and connected on the other end to display 102. Cable 106 enables data transfer and/or other communication between mobile device 104 and display 102. A cable may take many forms, such as, but not limited to, a form where one end connects to a display through a HDMI™ (High Definition Multimedia Interface) port and the other end connects to a mobile device, such as a smartphone, through a micro-USB™ (Universal Serial Bus) port.

In other embodiments, a cable may not be directly connected to a mobile device that is received or supported by a mounting apparatus. For example, a cable may be connected to an adapter dongle (such as Lightning Digital AV Adapter™ by Apple Inc. of Cupertino, Calif.) or other device that will in-turn be connected to a smartphone that is received by a mounting apparatus. In certain other instances, a cable may not be used at all if the smartphone is able to wirelessly transfer data and/or wirelessly communicate with a display through software and/or hardware built into the smartphone and/or other applicable device, such as through: Wi-Fi™ internet connection; cellular data transfer; Apple AirPlay®; Google Chromecast®; or Samsung All-Share™. Regardless whether mobile device 104 and display 102 are connected by a cable or connected wirelessly, both mobile device 104 and display 102 may serve as either a transferor or a transferee of data transfer and/or other communication. In other embodiments, a mobile device received or supported by a mounting apparatus may be connected either through a cable and/or wirelessly with a computer as opposed to the computer monitor that a mounting apparatus may be secured to. In such instances, either the computer or the mobile device received or supported by the mounting apparatus may be a transferor or a transferee of data transfer and/or other communication. In certain other instances, a user may desire to have a mobile device received or supported by the mounting apparatus without the need for data transfer and/or other communication, in which case a cable may also not be required.

Referring back to FIG. 1, mounting apparatus 100 enables a user to utilize and interact with mobile device 104 and display 102 in several aspects. One such aspect is video-conferencing. Mobile device 104 includes, as with many smartphones, a built-in camera that may be used for video-conferencing. Several software applications, such as Skype®, enable video-conferencing to be accomplished directly on a smartphone itself. The video-conferencing experience would be enhanced if accomplished with a larger screen (such as display 102) rather than on the smartphone itself. Among other things, a smaller screen may not be comfortably viewed by more than one user while, in contrast, a larger display may be more comfortably viewed by multiple users. Additionally, by using a larger display, a user may be able to utilize speakers that are built into the larger display, which are often superior to the speakers in smartphones.

Through cable 106, the video-conferencing image feed that would otherwise have appeared only on mobile device 104 can be mirrored or otherwise projected to display 102. However, video-conferencing on a larger display will be suboptimal unless the built-in camera on mobile device 104 is positioned for eye-contact with the user. During video-conferencing, the user will naturally look at display 102 in order to view the video-conferencing image feed from the other party or parties that the user is video-conferencing with. If the built-in camera on mobile device 104 is not positioned for eye-contact with the user while the user looks at display 102, the party or parties that the user is video-conferencing with will receive an image feed of the user looking away. Additionally, if mobile device 104 is not elevated off the ground to roughly correspond with the height of the user's head, the party or parties that the user is video-conferencing with may see the user from a vantage point that is unnatural for the purposes of conferencing. Mounting apparatus 100 enables the built-in camera on mobile device 104 to be positioned for eye-contact with the user and enables mobile device 104 to be elevated to roughly the same height as the user's head even while the user simply looks at display 102. Furthermore, certain smartphones have a built-in front facing camera and a rear facing camera, the latter of which is of superior quality. For the reason that a user may look at display 102 instead of the screen built into mobile device 104 during a video-conference, the user may also utilize the built-in rear facing camera on mobile device 104 (not visible in FIG. 1) for video-conferencing in lieu of the built-in front facing camera. Moreover, mounting apparatus 100 enables a user to accomplish video-conferencing at low cost by utilizing common household items which users may already own, such as a smartphone and television (or smartphone, computer and computer monitor).

Beyond video-conferencing, mounting apparatus 100 enables a user to utilize and interact with mobile device 104 and/or display 102 in other aspects. For example, as a user looks at display 102, a user may perform physical movements or gestures that mobile device 104 recognizes, which can facilitate interaction between the user and mobile device 104 and/or display 102. Among other things, these movements and gestures may be used to facilitate navigation of menus, enable the user to make selections, or permit interactive games to be played by one or more users. In other situations, a user may also utilize voice or sounds that mobile device 104 recognizes through its built-in or external microphone, which can also facilitate interaction between the user and mobile device 104 and/or display 102.

As previously referenced, whether an article received by a mounting apparatus and a display (or a computer) are connected by a cable or connected wirelessly, either the mobile device and/or the display may serve as a transferor or a transferee of data transfer and/or other communication. In other instances, a mobile device received or supported by a mounting apparatus may be connected either through a cable and/or wirelessly with a computer as opposed to the display that a mounting apparatus may be secured to. In such instances, either the computer and/or the mobile device received or supported by the mounting apparatus may be a transferor or a transferee of data transfer and/or other communication. An example of a mobile device serving as a transferor is when the source of a movie playing on a display is the Netflix® software application running on the mobile device. An example of a mobile device serving as a transferee is when the mobile device receives commands from a display or a computer to capture images and/or sounds through the built-in camera and/or microphone in the mobile device.

Even where a mobile device is not transferring data and/or otherwise communicating with a display or computer, a user may position the mobile device on a mounting apparatus for a variety of uses. For example, where a user is sitting in front of a computer monitor and the user does not have a need for data transfer and/or other communication between the user's smartphone and computer, the user may still position a smartphone on the mounting apparatus so that the smartphone can be readily accessed and interacted with by the user as an independent article.

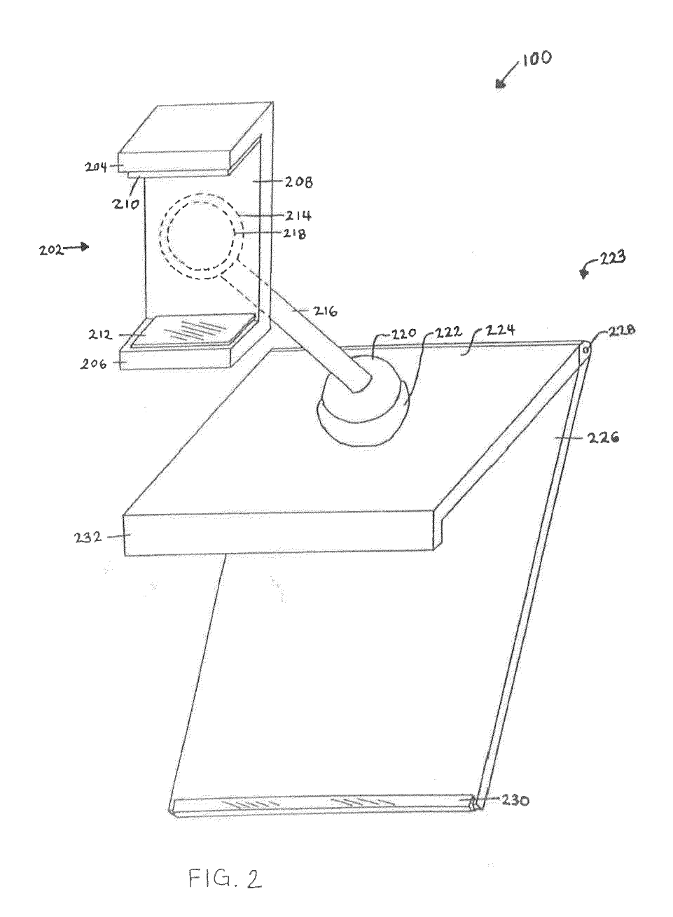

In FIG. 2, mounting apparatus 100 is shown to include article receiver 202, which may be used to releasably receive or support other articles (such as mobile device 104 from FIG. 1). Article receiver 202 includes first arm 204 and second arm 206, which extend from body 208 to form a receiving cavity. While first arm 204 and second arm 206 are configured to be aligned vertically from one another, first arm 204 and second arm 206 may be aligned horizontally in other embodiments. First arm 204 and second arm 206 are shown as integral to body 208 (as opposed to first arm 204 and second arm 206 being separate from body 208). In other embodiments, first arm 204 and second arm 206 may be connected to body 208. The sides of first arm 204 and second arm 206 that form the receiving cavity are connected to first cushion 210 and second cushion 212, respectively. When a mobile device (such as mobile device 104 from FIG. 1) is inserted into the receiving cavity formed by first arm 204 and second arm 206, the mobile device will cause first cushion 210 and second cushion 212 to depress toward first arm 204 and second arm 206, respectively. In other embodiments, first cushion 210 and second cushion 212 may be omitted. There are many other forms that article receiver 202 may take. For example, either or both of first arm 204 and second arm 206 may be adjustable to be either closer or farther from the other to accommodate different sized objects in the receiving cavity. The adjustment of either or both of first arm 204 and second arm 206 may be accomplished through a spring (e.g., coiled compression spring, etc.) or a telescopic stem placed in a vertical position in a cavity within body 208 and connected on one end to first arm 204 and connected on the other end to second arm 206. In other embodiments, more than two arms or no arms may be used.

Referring back to FIG. 2, article receiver 202 is shown to include receiver socket 214, within which a sphere shaped cavity acts as a socket to receive first ball 218 on stem 216. The ball-and-socket joint enables considerable adjustment to the angles and orientations that article receiver 202 may be positioned. For example, a mobile device received by article receiver 202 may not only be tilted in any direction (e.g., left, right, up or down), but it may also be rotated from a landscape orientation to a portrait orientation, or vice versa. In other embodiments, an alternative style of joint may be included (e.g., hinge joint pivoting on a single axis, compound hinge joint pivoting on multiple axes, etc.) or a joint may not be included. On the other end of stem 216 is second ball 220, which is received by base socket 222 on base 223. Together, second ball 220 and base socket 222 enable stem 216 to not only be raised and lowered, but also to be positioned in many other orientations. In other embodiments, there may be multiple stems that are sequentially and pivotally connected to an article receiver. Such configuration would, among other things, allow an article receiver to be extended closer or farther from the user. In some embodiments, a stem may be telescopic to permit further extension. In other embodiments, a stem may not be included in a mounting apparatus because an article receiver may simply be integral to or directly connected to a base.

Still referring to FIG. 2, base 223 includes platform 224 which has a pivot end that is pivotally connected to leg 226 through a single axis hinge joint about rod 228 that allows leg 226 to pivot closer or farther from the distal end of platform 224. When leg 226 is pivoted as close as possible to the distal end of platform 224, it will be roughly parallel to platform 224. In this configuration, and in other configurations in alternative embodiments, a mounting apparatus may also be positioned on a flat surface (such as a desktop or shelf) as opposed to being secured to a display. In another embodiment, a different joint (e.g., ball-and-socket, etc.) may be used to connect platform 224 and leg 226, or no joint may be used. In other embodiments, more than one leg may be sequentially connected to the pivot end of platform 224. Rubberized padding 230 is connected to the distal end of leg 226. The distal end of platform 224 is shown with lip 232 protruding. While lip 232 is shown as integral to platform 224, in other embodiments, a lip may be separately connected.

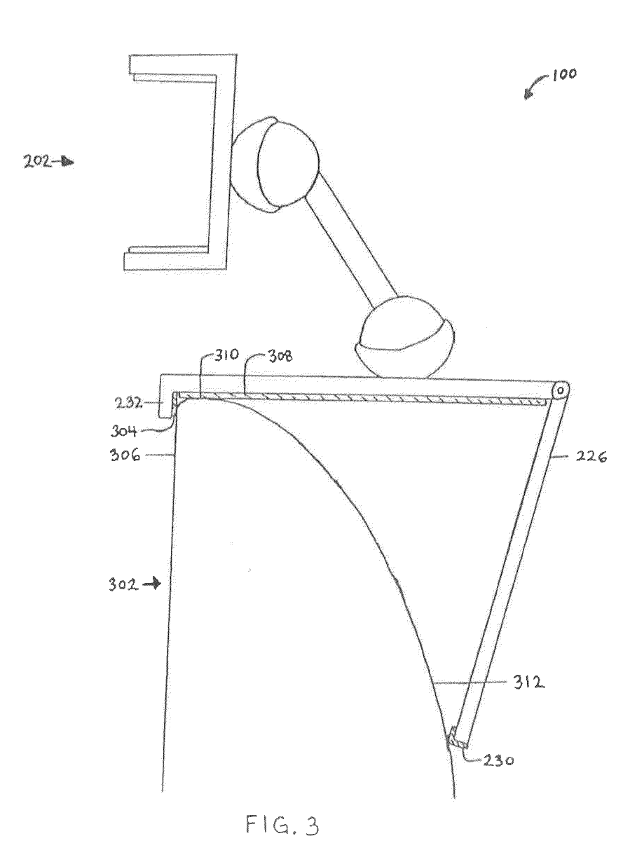

In FIG. 3, mounting apparatus 100 is shown on display 302. Rubberized padding 304 (connected to lip 232) can be seen pressing against display front-side 306 while rubberized padding 230 (connected to leg 226) presses against display back-side 312 and rubberized padding 308 presses against display top-side 310. In other embodiments, a different number and/or configuration of sides on a display may be pressed against by a mounting apparatus. In other embodiments, some or all of the rubberized padding may be replaced or combined with adhesives, foam or completely omitted.

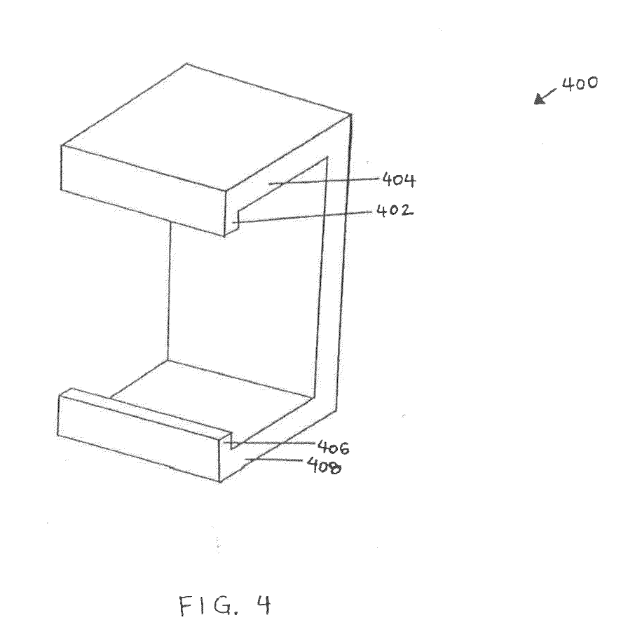

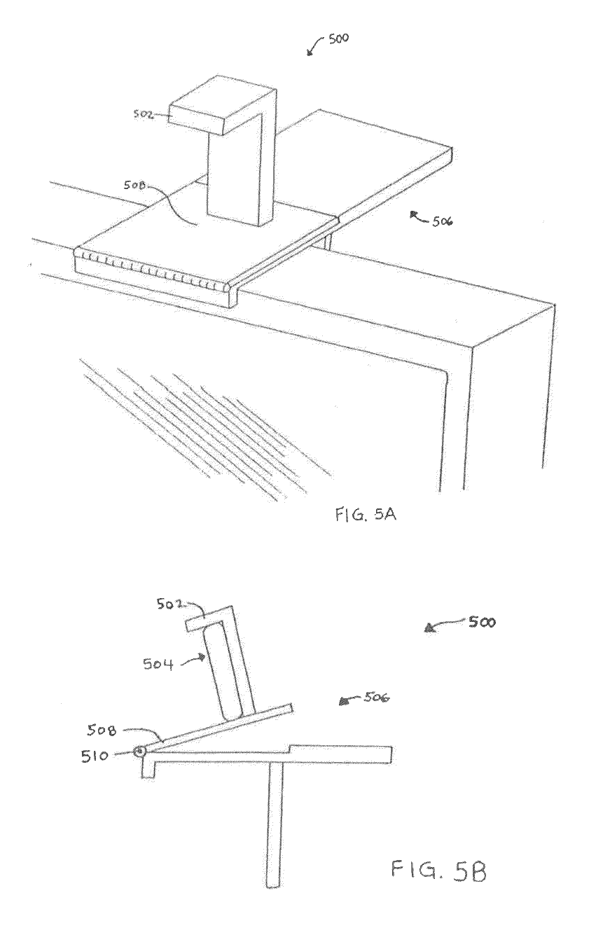

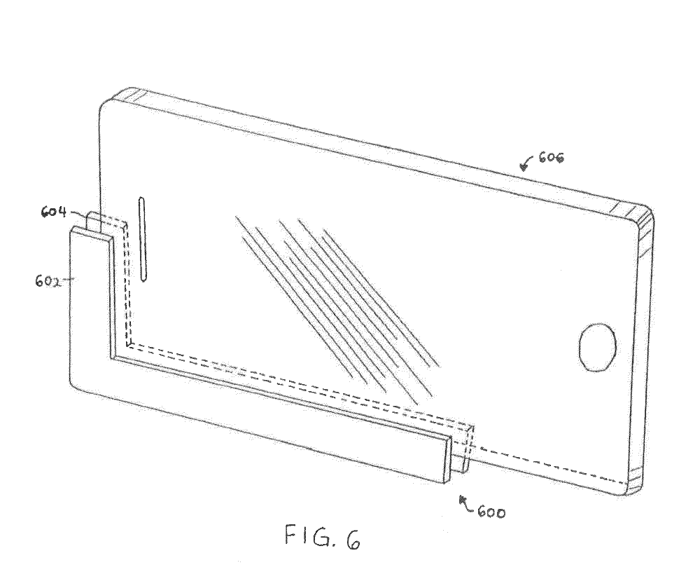

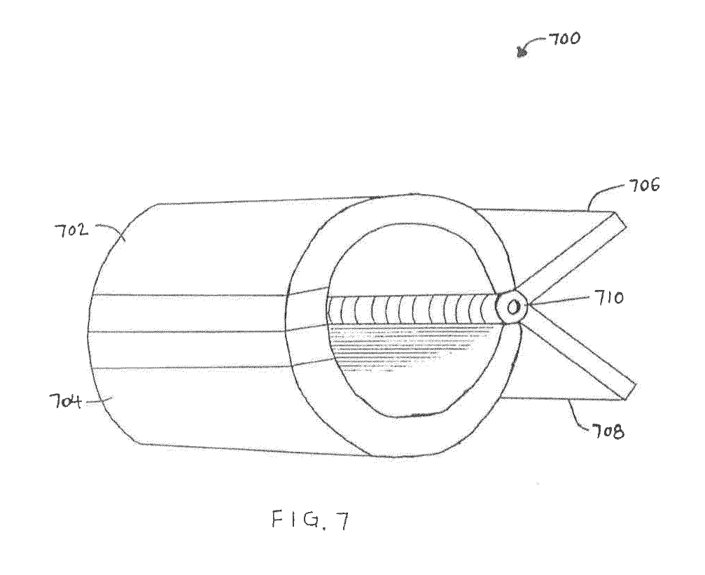

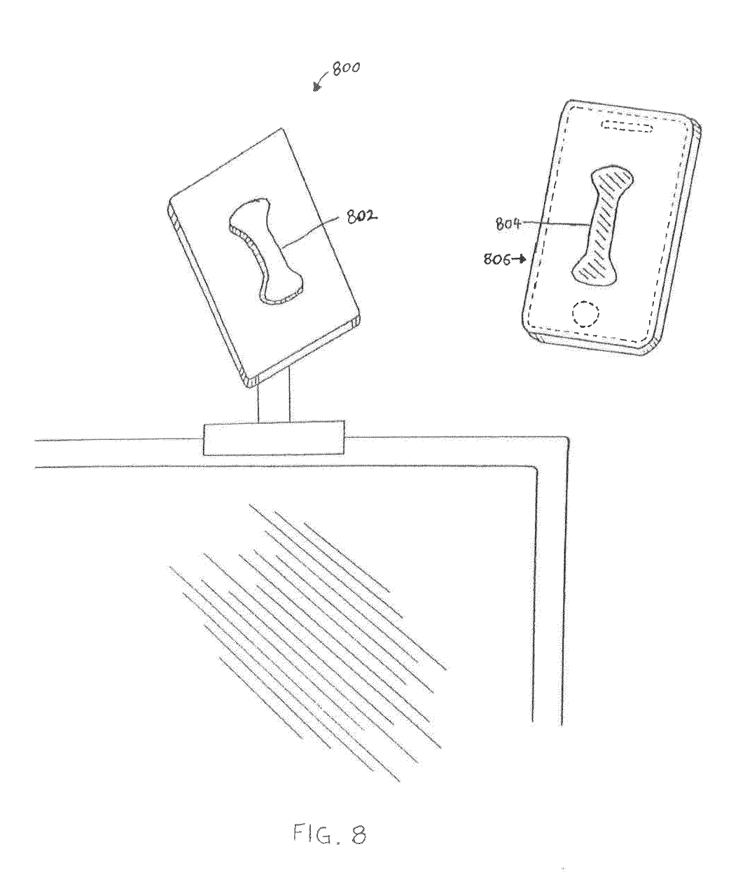

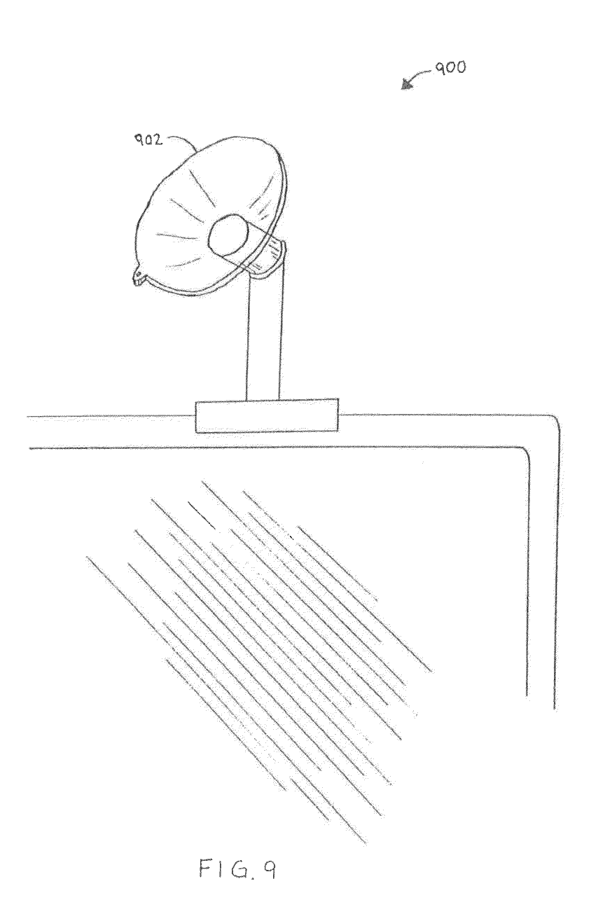

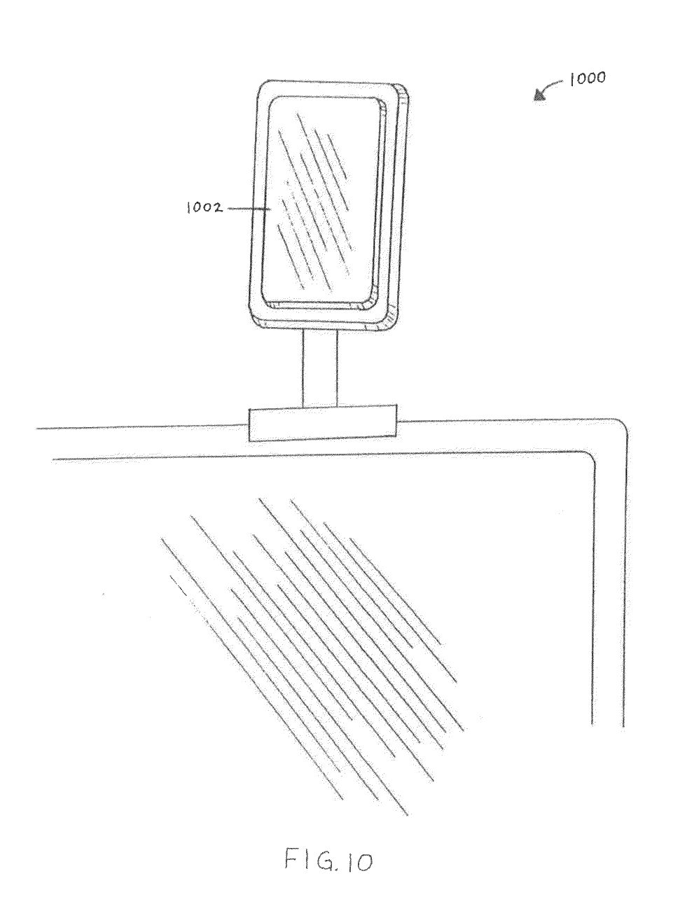

An article receiver need not take the form of article receiver 202 in FIGS. 2 and 3. On the contrary, an article receiver can take many forms. FIGS. 4 through 10 illustrate certain other embodiments. In FIG. 4, article receiver 400 is shown with first lip 402 (on first arm 404) and second lip 406 (on second arm 408). The addition of first lip 402 and second lip 406 provides additional assurance that an mobile device will not fall out of the receiving cavity created by first arm 404 and second arm 408. In FIGS. 5A and 5B, article receiver 500 is able to receive or support articles in the cavity created by arm 502 and platform 506. As seen in FIG. 5B, platform subsection 508 pivots about pivot rod 510 such that platform subsection 508 may be raised to permit the screen on mobile device 504 to be tilted downward. In FIG. 6, article receiver 600 uses first arm 602 and second arm 604 to receive or support mobile device 606. In other embodiments, a screw or spring based mechanism may be used to bring first arm 602 and second arm 604 closer or farther from each other. In FIG. 7, article receiver 700 includes first arm 702 and second arm 704 which are pivotally coupled with spring-hinge mechanism 710. First handle 706 and second handle 708 may be pressed together against the biasing force of spring-hinge mechanism 710 to pivot the respective distal ends of first arm 702 and second arm 704 away from each other. In FIG. 8, article receiver 800 includes protrusion 802, which is a physical protrusion specifically shaped to be received or supported by cavity 804 on smartphone case 806. In other embodiments, the physical protrusion may be on the smartphone case so as to be received or supported by an article receiver. In FIG. 9, article receiver 900 includes suction cup 902 that utilizes suction to receive articles. In other embodiments, extremely small suction cups or micro-suction may be used. In FIG. 10, article receiver 1000 includes engaging platform 1002, which may receive or support articles through (i) adhesive materials on the engaging platform, such as molded polyurethane (also known as PU Gel); or (ii) magnetic interaction, which may be accomplished by connecting magnetic or ferromagnetic materials to engaging platform 1002. It is to be noted that the article receivers described herein are illustrative and not limiting.

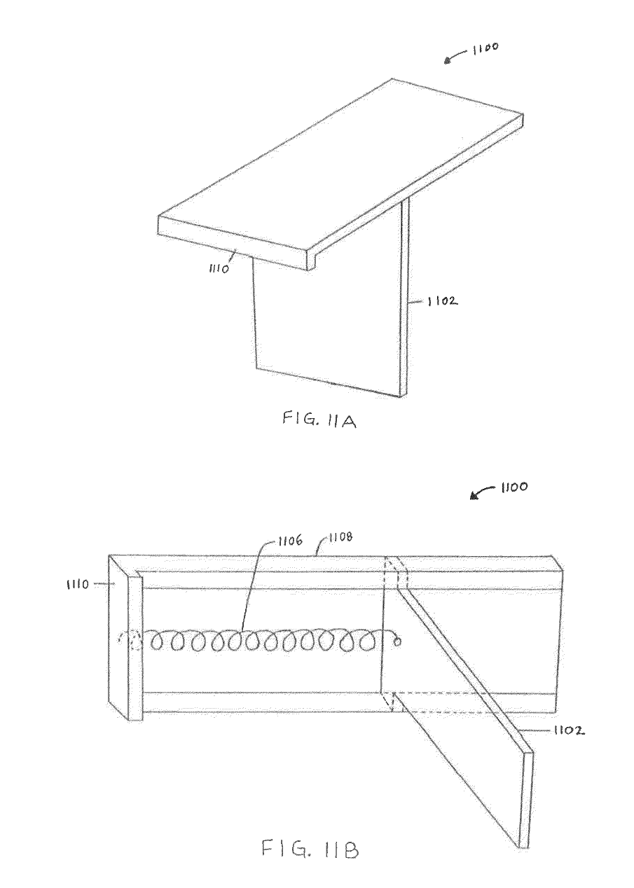

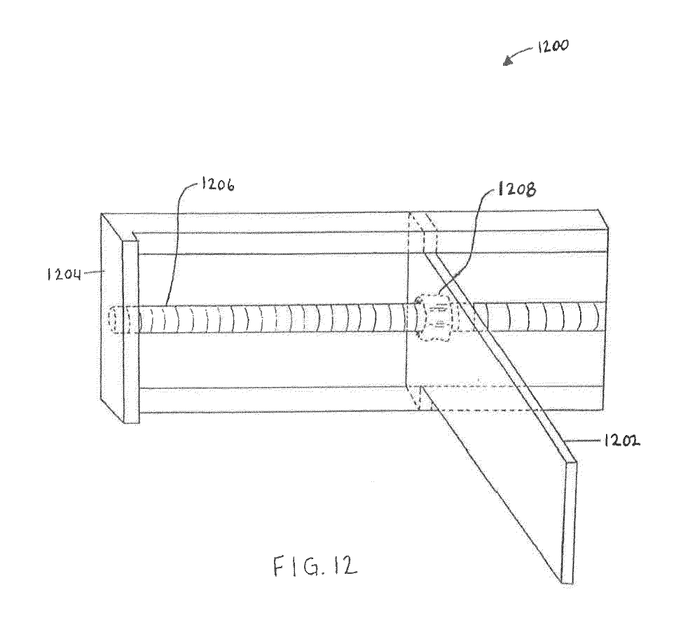

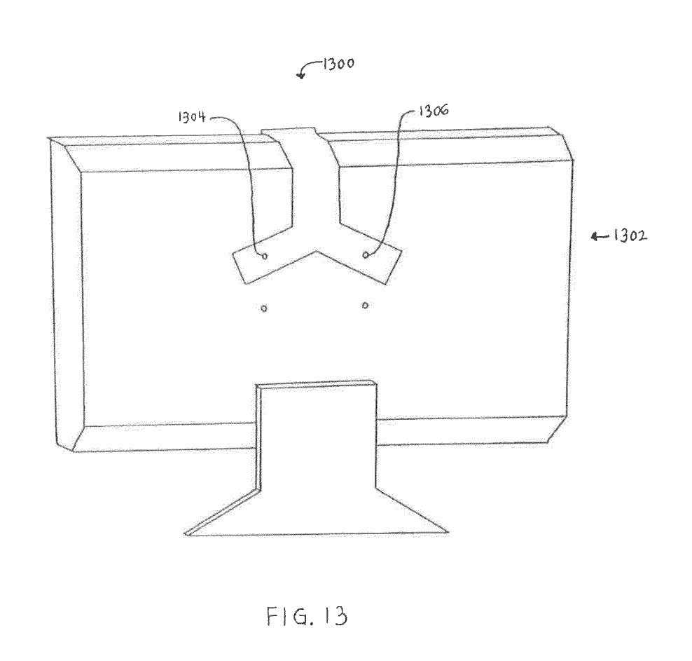

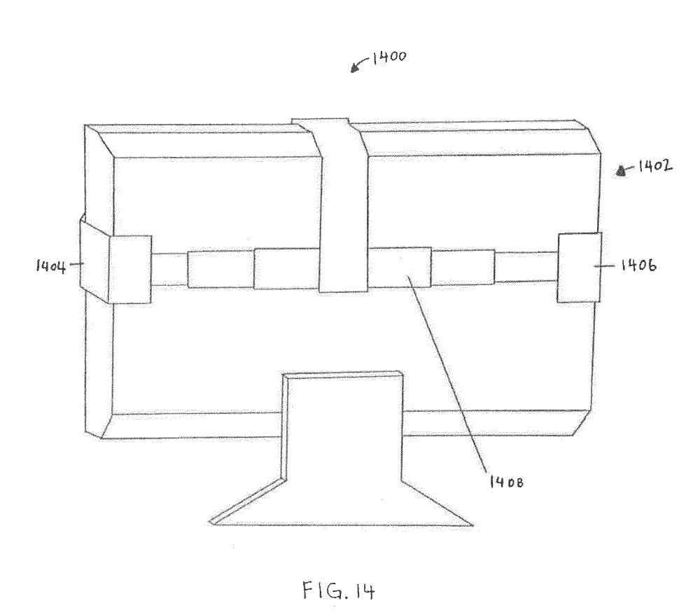

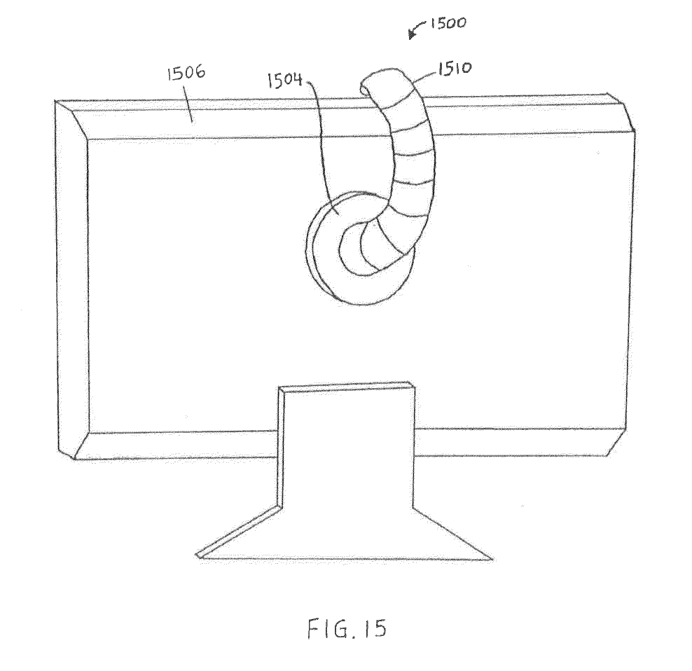

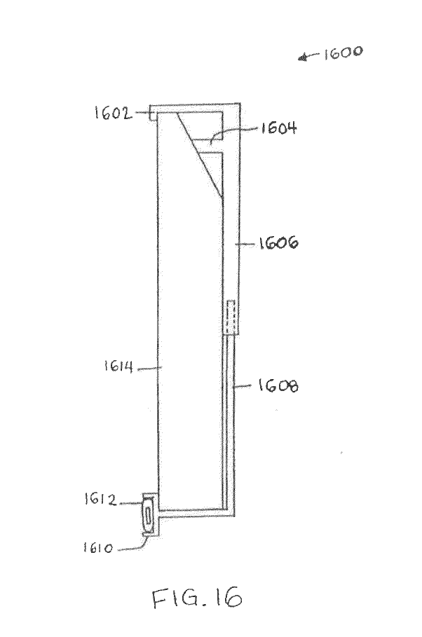

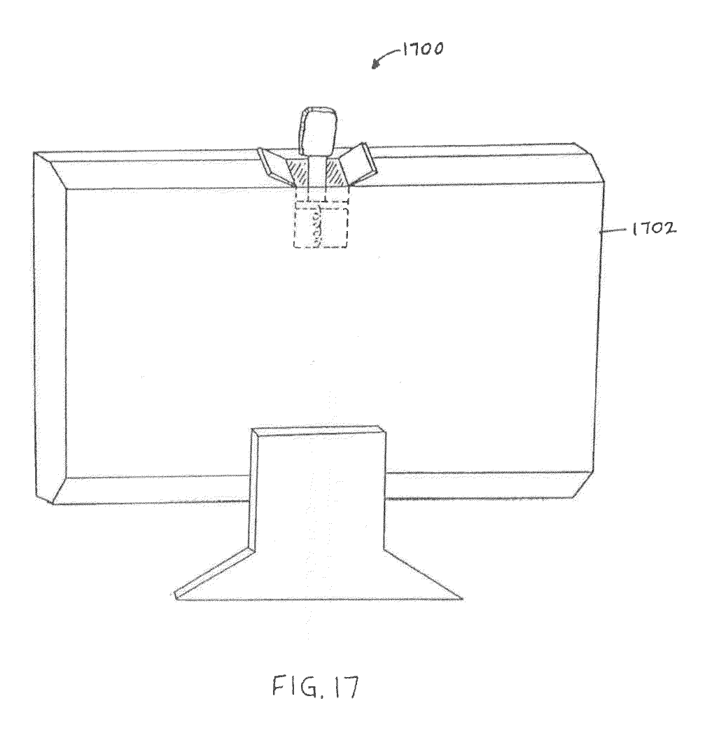

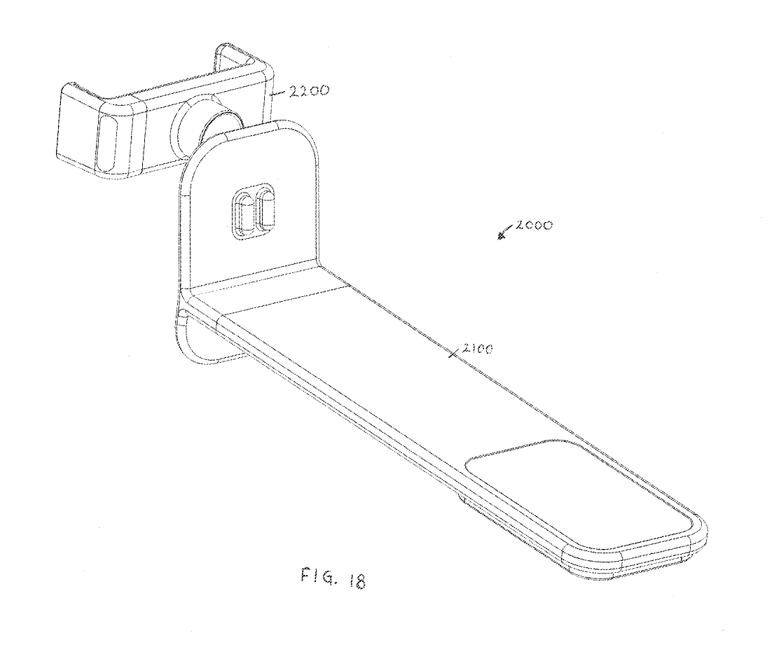

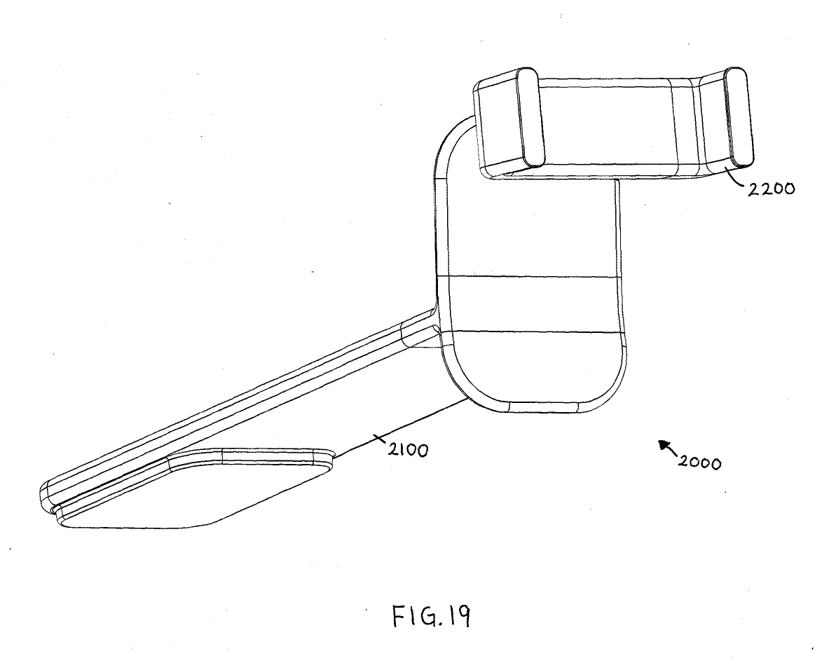

A base may also take many forms. FIGS. 11A through 16 illustrate certain other embodiments. In FIGS. 11A and 11B, base 1100 includes leg 1102, which may move farther or closer to lip 1110 so that base 1100 can accommodate displays of different sizes and shapes. FIG. 11B illustrates that as leg 1102 moves farther from lip 1110, it moves against the biasing force of spring 1106. Within platform 1108 is a cavity where leg 1102 is connected to spring 1106 through a spring retention element. The other end of spring 1106 is connected to lip 1110 through another spring retention element. In lieu of the spring based mechanism of base 1100 in FIG. 11A and 11B, base 1200 in FIG. 12 uses a bolt based mechanism to permit leg 1202 to move closer and farther from lip 1204. Leg 1202 moves along threaded pole 1206, and nut 1208 prevents leg 1202 from moving farther from lip 1204. In FIG. 13, base 1300 is positioned on display 1302 by way of screws inserted into first standard receptacle 1304 and second standard receptacle 1306. In FIG. 14, base 1400 includes first arm 1404 and second arm 1406, which are connected by a spring within telescoping rod 1408. In FIG. 15, base 1500 includes stem receptacle 1504, which is connected to display 1506 through the use of adhesives or other means. Stem receptacle 1504 is shown receiving flexible stem 1510. In other embodiments, in lieu of a flexible stem, a non-flexible stem or telescoping stem may be used. In FIG. 16, base 1600 includes lip 1602, brace 1604, and leg 1606. Leg 1606 has a cavity to receive stem 1608, which is connected to article receiver 1610 as it receives or supports article 1612 near the bottom of display 1614. In other embodiments, stem 1608 may also be connected to leg 1606 in a manner that would allow stem 1608 to be positioned or rotated below, above, left or right of leg 1606. It is to be noted that the bases described herein are illustrative and not limiting.

In other embodiments, a mounting apparatus may be integral to a display or built-into a display. FIG. 17 depicts mounting apparatus 1700 extending out of a cavity within display 1702. When mounting apparatus 1700 is not being used, it may be lowered into the cavity to avoid being seen by users. Mounting apparatus 1700 may be lowered into or raised out of the cavity through a spring-based mechanism, however, other mechanisms may be used in other embodiments. Whether a mounting apparatus is built-into a display, such as in FIG. 17, or separately connected to a display, such as in FIG. 1, a mounting apparatus may include a built-in dock and/or built-in cables to, among other things, charge an electrical device received or supported by the mounting apparatus and/or enable such device to transfer data and/or otherwise communicate. In other embodiments, a mounting apparatus may include a holder to secure various non-built-in cables, such as power cables, and/or connection cables, so that such cables can be more conveniently found by a user.

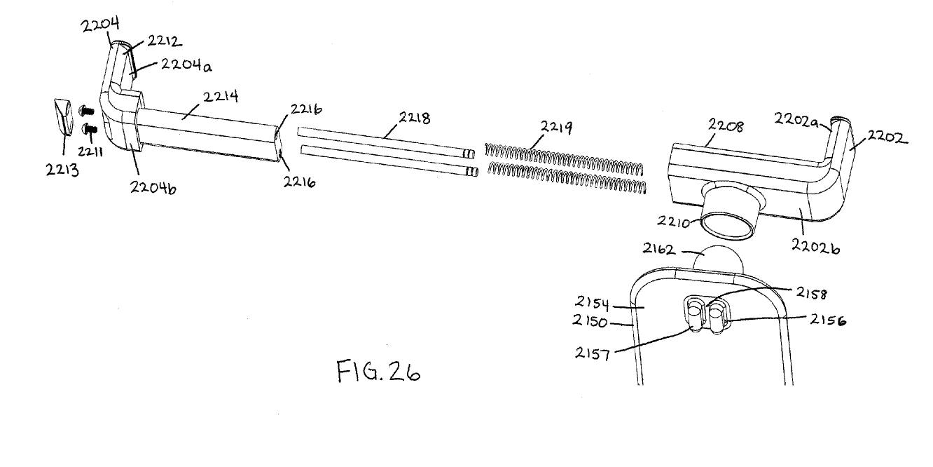

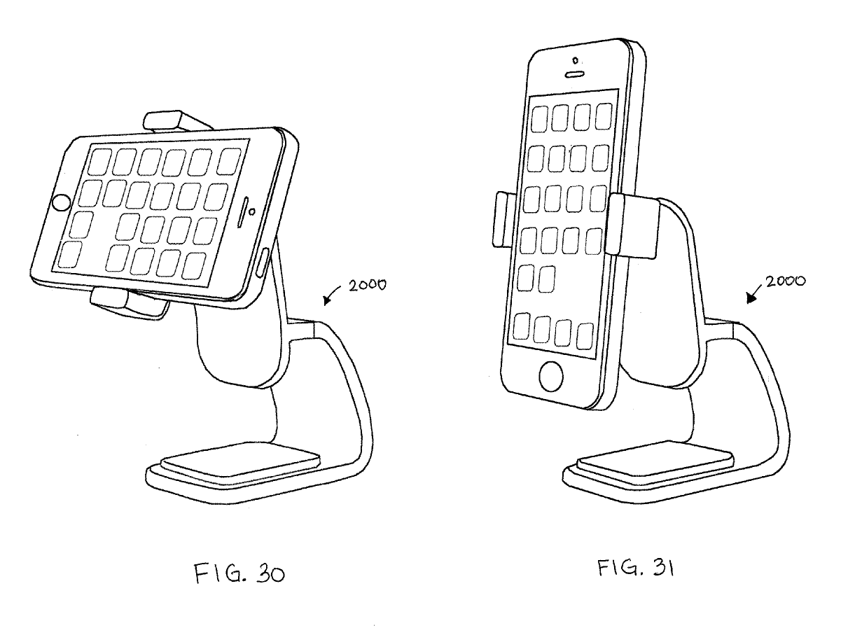

With reference now to FIGS. 18 and 19, there is illustrated a mounting apparatus 2000 in accordance with another embodiment of the present disclosure. Mounting apparatus 2000 includes a base 2100 and an article receiver 2200 adjustably coupled with base 2100. Base 2100 is selectively transitionable between an undeformed state (FIG. 18) and a deformed state (FIGS. 27 and 30) defining a desired curvature. Specifically, base 2100 may be deformed for mounting on a display 1 (FIG. 27) or for use as a standalone device on, e.g., a wide surface (FIGS. 30 and 31). Article receiver 2200 is adjustable to receive various mobile devices having various dimensions.

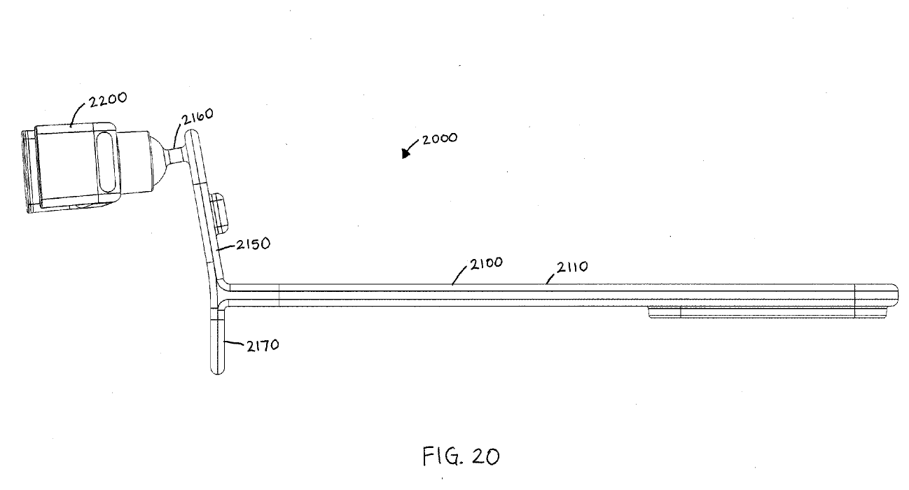

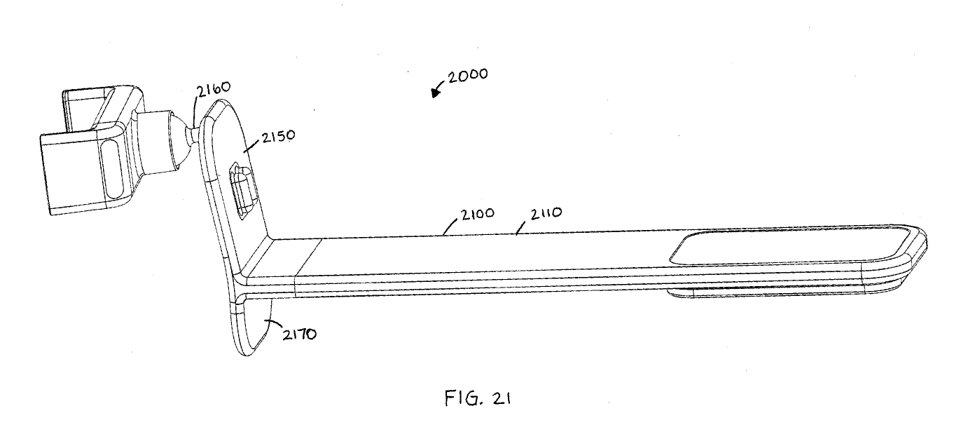

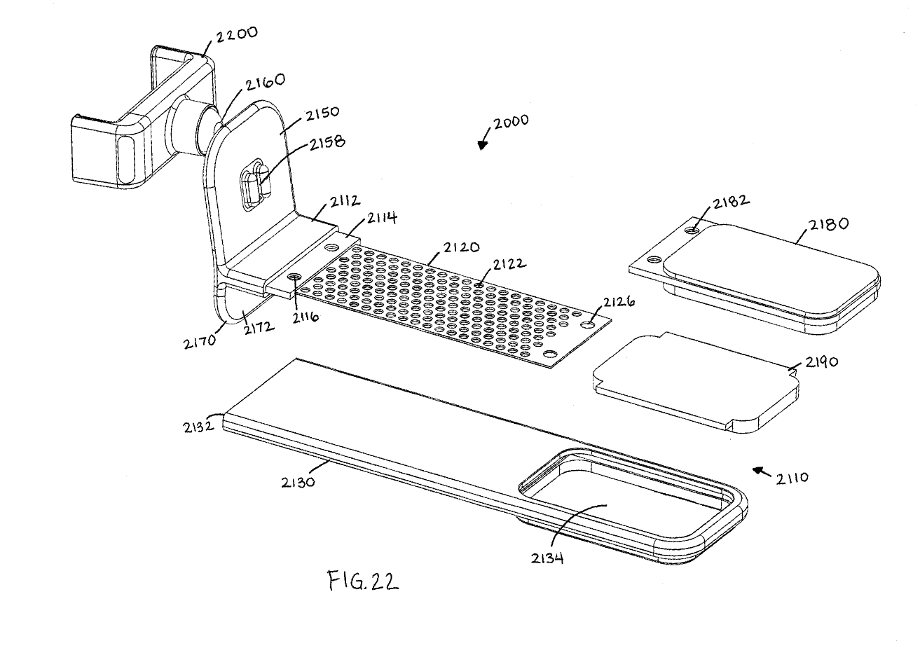

With reference to FIGS. 20-22, base 2100 includes a body portion 2110 and an anchoring portion 2170 configured to engage display 1 (FIG. 27). With particular reference to FIG. 22, body portion 2110 includes a protruding portion 2112 having a bendable member 2120 depending therefrom. Bendable member 2120 may be formed of a material that is sufficiently compliant to accommodate a desired shape of body portion 2110 when a bending force is applied to body portion 2110 by a user. Bendable member 2120 may be formed from a variety of materials such as, e.g., polymer, stainless steel, and shape memory alloys. Bendable member 2120 may define a plurality of bores 2122 to facilitate bending of bendable member 2120, and to reduce the weight of bendable member 2120 such that more weight is concentrated on a weighted mass 2190 having a predetermined weight. In other embodiments, a bendable member may not have a plurality of bores.

With continued reference to FIG. 22, body portion 2110 further includes a casing member 2130 configured to receive bendable member 2120 therein. Protruding portion 2112 of body portion 2110 may include a transition portion 2114 configured to engage a mouth of 2132 of casing member 2130. Mouth 2132 of casing member 2130 may be frictionally secured on transition portion 2114 of protruding portion 2112. However, it is also contemplated that screws (not shown) may be utilized to secure casing member 2130 on transition portion 2114. Transition portion 2114 may define bores 2116 to receive the screws therethrough. In other embodiments, casing member 2130 may be secured on transition portion 2114 through plastic injection over molding.

Casing member 2130 defines a cavity 2134 configured to receive weighted mass 2190. Specifically, weighted mass 2190 is placed in a mounting member 2180 dimensioned to be received in cavity 2134 of casing member 2130. Weighted mass 2190 in body portion 2110 counter balances and/or compensates the weight of mobile device 5000. For example, weighted mass 2190 provides weight concentration adjacent tail end 2117 of body portion 2110.

Mounting member 2180 may be attached to casing member 2130 through the use of, e.g., adhesive, welding, or friction fit. Alternatively, screws (not shown) may be utilized to secure mounting member 2180 on casing member 2130. Bendable member 2120 may define screw holes 2126 and mounting member 2180 may define screw holes 2182 to receive the screws. Mounting member 2180 may be detachably coupled to casing member 2130 such that weighted mass 2190 may be selectively placed based on the specifications of each mobile device mounted on article receiver 2200. In other embodiments, a mounting member for a weighted mass may not be utilized because one or more weighted masses and a bendable member may be encapsulated by a casing member through plastic injection over molding. However, it is also envisioned that weighted mass 2190 and casing member 2130 may be integrally formed as a single construct.

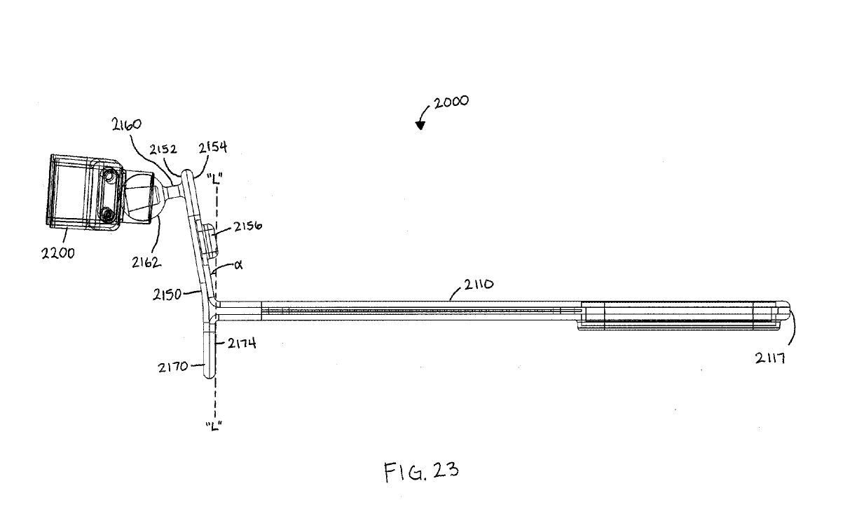

With reference now to FIG. 23, a stem 2150 extends from body portion 2110. Stem 2150 may define, e.g., an acute angle a, with respect to a lateral axis “L-L”. Stem 2150 includes an anterior surface 2152 and a posterior surface 2154. Anterior surface 2152 includes an attaching member 2160 configured to adjustably support article receiver 2200. Attaching member 2160 may include a ball and socket joint. It is also contemplated that other types of joints may be utilized such as, e.g., hinge joint pivotable about a single axis and compound hinge joint pivotable about multiple axes.

With brief reference to FIG. 26, posterior side 2154 of stem 2150 includes a cable holder 2156 made of, e.g., a compressible material. Cable holder 2156 may be formed of, e.g., thermoplastic elastomers, overmolded or fastened to stem 2150. Cable holder 2156 may include a pair of teeth 2157 defining a gap 2158 therebetween. Gap 2158 may be dimensioned to retain a cable (not shown) such as, e.g., a power adapter cable or adapter dongle for mobile device 5000 (FIG. 27), therein.

With reference back to FIG. 22, anchoring portion 2170 is configured to engage, e.g., anterior edge 5 (FIG. 27), of display 1. Anchoring portion 2170 may be, e.g., substantially perpendicular with body portion 2110. Anchoring portion 2170 may further include a liner 2172 made of a compressible material such as, e.g., foam, gel, or thermoplastic elastomer overmolded onto a posterior surface 2174 (FIG. 23) of anchoring portion 2170. Use of liner 2172 inhibits damage to anterior edge 5 (FIG. 27) of display 1 and provides improved traction on anterior edge 5 of display 1 to enhance securement of body 2100 on display 1.

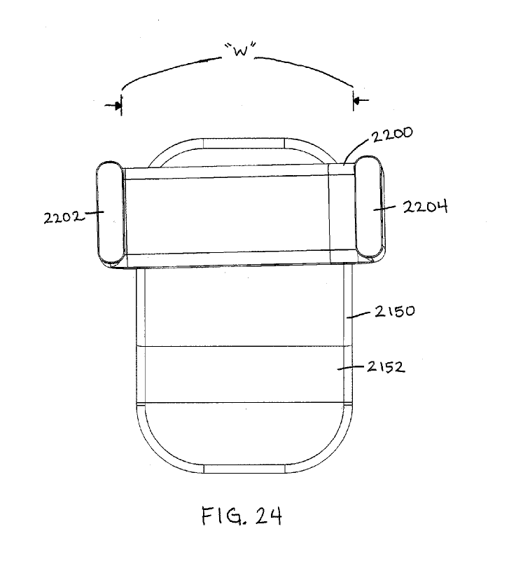

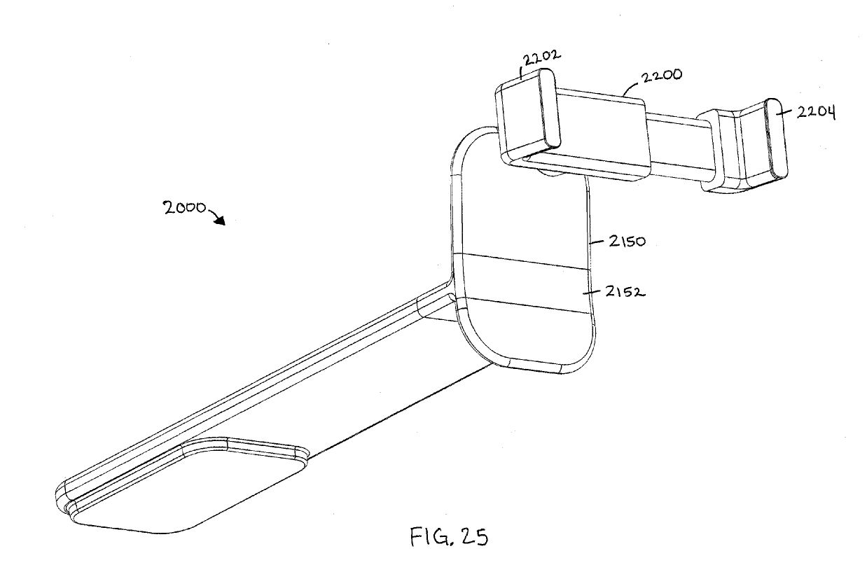

With reference now to FIGS. 24-26, article receiver 2200 is rotatably supported on anterior side 2152 of stem 2150. Article receiver 2200 includes first and second arms 2202, 2204 defining a receiving space “W” therebetween. Receiving space “W” is dimensioned to receive mobile device 5000 (FIG. 27) therein. With particular reference to FIG. 26, first arm 2202 includes an anterior surface 2202a and a posterior surface 2202b. Anterior surface 2202a of first arm 2202 includes a liner 2208 configured to enhance securement of mobile device 5000 (FIG. 27) between first and second arms 2202, 2204. Posterior surface 2202b of first arm 2202 defines a socket 2210 configured to receive a ball joint 2162 of attaching member 2160. Second arm 2204 includes an anterior surface 2204a and a posterior surface 2204b. Anterior surface 2204a also includes a liner 2212 configured to enhance securement of mobile device 5000 (FIG. 27) between first and second arms 2202, 2204. Second arm 2204 includes a tongue 2214 configured and dimensioned to be received in a cavity (not shown) defined in first arm 2202. Tongue 2214 defines a pair of bores 2216 configured to receive a respective rod 2218 therein. In other embodiments, a tongue may define a single bore to receive a single rod. With reference back to FIG. 26, each rod 2218 supports a biasing member 2219. Each end of biasing member 2219 is coupled to respective first and second arms 2202, 2204. Further, screws 2211 secure rods 2218 to second arm 2202. A cover 2213 may be provided to enclose screws 2211. Under such a configuration, second arm 2204 may be transitionable between a retracted position (FIG. 24) and an expanded position (FIG. 25). Second arm 2204 may be biased toward the retracted position. In this manner, mobile device 5000 disposed between first and second arms 2202, 2204 are securely held therein by first and second arms 2202, 2204. Further, various mobile devices having various widths may be received between first and second arms 2202, 2204.

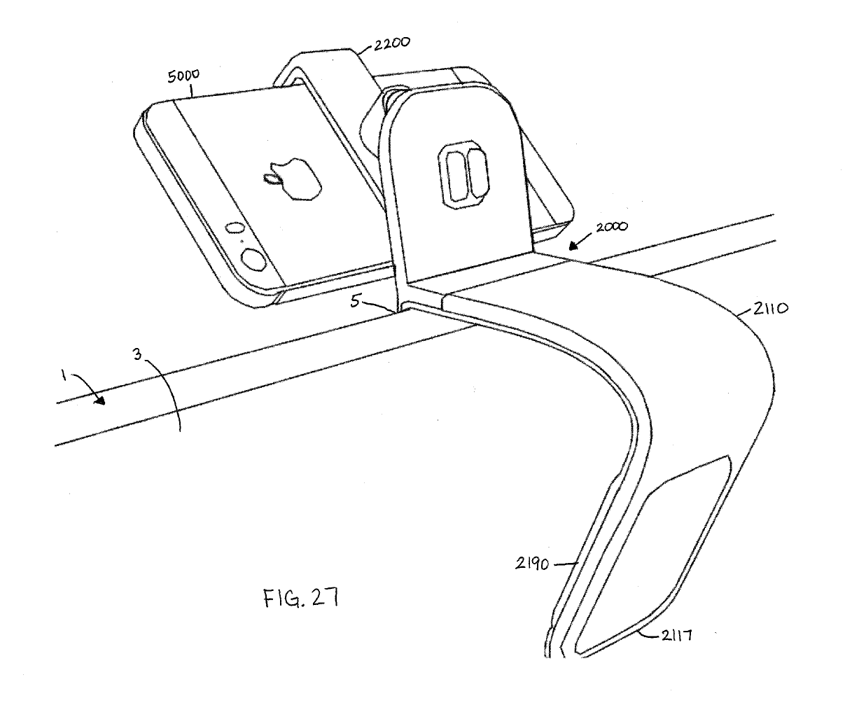

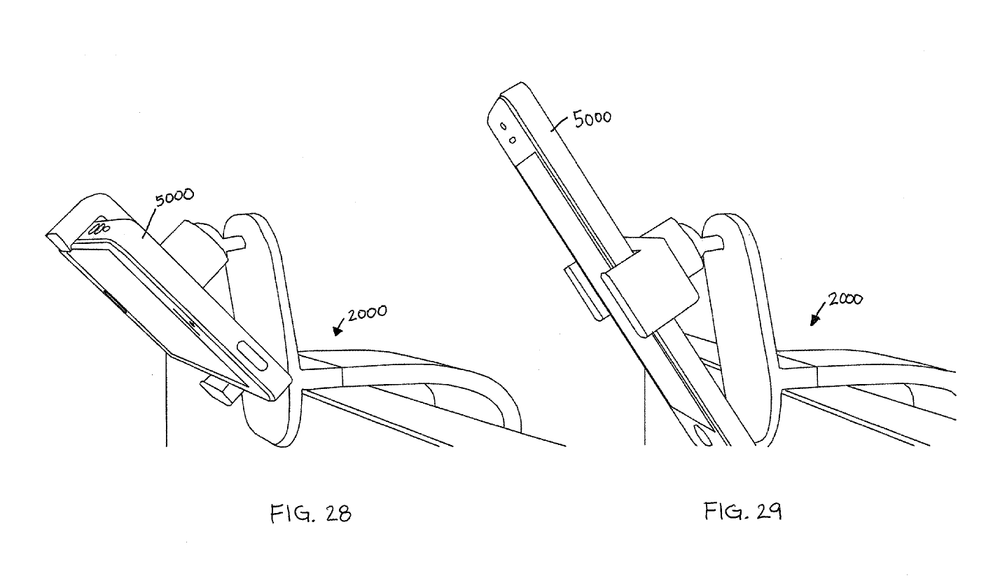

In use, mobile device 5000 is placed between first and second arms 2202, 2204 of article receiver 2200. Thereafter, body portion 2110 is deformed from the undeformed state (FIG. 18) to a deformed state (FIG. 27) to achieve a desired curvature of body portion 2110 (FIG. 27) by applying a bending force to body portion 2110. Body portion 2110 may be deformed such that when mounting apparatus 2000 is mounted on display 1, a tail end 2117 of body portion 2110 engages a posterior surface 3 (FIG. 27) of display 1, and anchoring portion 2170 and body portion 2110 securely engage anterior edge 5 (FIG. 27) of display 1. Under such a configuration weighted mass 2190 in body portion 2110 counter balances and/or compensates the weight of mobile device 5000. In this manner, mobile device 5000 may be disposed anterior to display 1 and may also be rotated or swiveled to the desired orientation without affecting the mounting stability and securement of mounting apparatus 2000 on display 1. At this time, the user may adjust the orientation of article receiver 2200 supporting mobile device 5000 to a desired orientation, e.g., landscape mode (FIG. 28) or portrait mode (FIG. 29). The user may further adjust, e.g., swivel, article receiver 2200 such that mobile device 5000 is at the user's eyelevel. Mobile device 5000 supported on mounting apparatus 2000 may be tethered to a computer (not shown) connected to display 1, which would enable mobile device 5000 to be a transferor of data and/or other communication to the computer, or vice versa. For example, the camera feature of mobile device 5000 may be utilized by the computer and its applications.

With reference now to FIGS. 30 and 31, it is also envisioned that body portion 2110 may be deformed to support mobile device 5000 on, e.g., a flat surface. Under such a configuration, mobile device 5000 may be placed on a surface other than display 1. In this manner, mounting apparatus 2000 supporting mobile device 5000 may be placed at a more suitable location when the camera function of mobile device 5000 is utilized.

The various aspects, embodiments, implementations or features of the described embodiments can be used separately or in any combination. Various aspects of the described embodiments can be implemented by software, hardware or a combination of hardware and software. Although the illustrative embodiments of the present disclosure have been described herein with reference to the accompanying drawings, the above description, disclosure, and figures should not be construed as limiting, but merely as exemplifications of particular embodiments. For example, stem 2150 may be telescopic to permit further extension. It is to be understood, therefore, that the disclosure is not limited to those precise embodiments, and that various other changes and modifications may be effected therein by one skilled in the art without departing from the scope or spirit of the disclosure.

What is claimed is:

1. A mounting apparatus for supporting a mobile device on a display, comprising:
a base configured to engage the display;
a stem portion extending from the base; and
an article receiver coupled to the stem portion, the article receiver configured to releasably receive the mobile device.

2. The mounting apparatus according to claim 1, wherein the base includes a body transitionable between an undeformed state and a deformed state, the body including a first end and a second end, the first end including a weighted mass having a predetermined weight.

3. The mounting apparatus according to claim 2, wherein the article receiver is adjustably coupled to the stem portion, the article receiver having first and second arms configured for relative movement between a retracted position and an expanded position, the first and second arms configured to securely engage the mobile device therebetween.

4. The mounting device according to claim 3, wherein the base includes a bendable member.

5. The mounting device according to claim 4, wherein the base further includes a casing member dimensioned to enclose the bendable member therein.

6. The mounting device according to claim 5, wherein the casing member defines a cavity configured to receive the weighted mass therein.

7. The mounting device according to claim 6, wherein the weighted mass is detachably supported within the cavity of the casing member.

8. The mounting device according to claim 5, wherein the weighted mass and the casing member are integrally formed.

9. The mounting device according to claim 3, further comprising an anchoring portion extending laterally from the second end of the base.

10. The mounting device according to claim 9, wherein the anchoring portion includes an anterior surface and a posterior surface including a liner formed of a compressible material.

11. The mounting device according to claim 9, wherein the anchoring portion defines a lateral axis, the stem portion defining an acute angle with respect to the lateral axis.

12. The mounting device according to claim 3, wherein the stem portion and the article receiver include a ball and socket joint.

13. The mounting device according to claim 3, wherein the stem portion includes an anterior surface and a posterior surface, the article receiver coupled to the anterior surface of the stem portion.

14. The mounting device according to claim 3, further comprising a holder configured to receive a cable therein.

15. The mounting device according to claim 3, wherein the first and second arms of the article receiver are biased toward the retracted position.

16. A method of mounting a mobile device to a display, comprising:
providing a mounting device including:
a base; and
an article receiver;
placing the mobile device on the article receiver; and
placing the mounting device on the display.

17. The method according to claim 16, wherein placing the mounting device on the display includes positioning the mobile device above the display.

18. The method according to claim 16, wherein placing the mounting device on the display includes positioning the mobile device anterior to the display.

19. The method according to claim 16, further comprising connecting the mobile device to the display through either a wired or wireless connection to facilitate data transfer and communication between the mobile device and the display.

20. The method according to claim 16, further comprising connecting the mobile device to a computer through either a wired or wireless connection to facilitate data transfer and communication between the mobile device and the computer.

21. The method according to claim 16, further comprising adjusting an orientation of the mobile device such that a camera of the mobile device is positioned at an eyelevel of a user.
